(19) United States
(12) Patent Application Publication
(10) Pub. No.: US 2007/0172810 A1
(43) Pub. Date: Jul. 26, 2007

(54) Systems and methods for generating reading diagnostic assessments

(75) Inventors: Richard Douglas McCallum, San Anselmo, CA (US); Richard William Capone, Kensington, CA (US)

Correspondence Address: TRAN & ASSOCIATES, 6768 MEADOW VISTA CT., SAN JOSE, CA, 95135, US

(73) Assignee: LET'S GO LEARN, INC.

(21) Appl. No.: 11/340,873

(22) Filed: Jan. 26, 2006

(51) Int. Cl. G09B 3/00

(52) U.S. Cl. 434/353; 434/169

(57) ABSTRACT

Systems and methods are disclosed to provide educational assessment of reading performance for a student by receiving a log-in from the student over a network; presenting a new concept to the student through a multimedia presentation; testing the student on the concept at a predetermined learning level; collecting test results for one or more concepts into a test result group; performing a diagnostic assessment of the test result group; and adaptively modifying the predetermined learning level based on the adaptive diagnostic assessment and repeating the process at the modified predetermined learning level for a plurality of sub-tests.

This Application is related to application Ser. No. ______, filed on Jan. 26, 2006 and entitled “ADAPTIVE DIAGNOSTIC ASSESSMENT ENGINE”, the content of which is incorporated by reference.

### BACKGROUND

The present invention relates to diagnostic assessment of K-12 students and adult learners.

Today educators are increasingly being asked to evaluate and justify the actions they undertake in the process of educating students. This increase in accountability has placed new demands on educators as they seek to evaluate the effectiveness of their teaching methodology. The U.S. educational system revolves around the teaching of new concepts to students and the subsequent confirmation of the students' mastery of the concepts before advancing the students to the next stage of learning. This system relies on the validity of the tests as well as accurate assessment of the test results.

The building of a valid test begins with accurate definitions of the constructs (i.e., the knowledge domains and skills) to be assessed. If the assessment activities in a test (i.e., the test items) tap into the constructs that the test is designed to assess, then the test has construct validity. Although additional factors affect overall test validity, construct validity is the basic logical bedrock of any test.

The traditional outcome of an educational test is a set of test scores reflecting the numbers of correct and incorrect responses provided by each student. While such scores may provide reliable and stable information about students' standing relative to a group, they may not indicate specific patterns of skill mastery underlying students' observed item responses. Such additional information may help students and teachers better understand the meaning of test scores and the kinds of learning which might help to improve those scores.

An assessment system can be used to provide assessment inferences about the student's learning progress. The assessment system can determine whether test results support a valid conclusion about a student's level of skill knowledge or cognitive abilities. A balanced assessment can cover various aspects of reading or mathematical knowledge: skills, conceptual understanding, and problem solving. Melding together these different types of assessment is important in coming to understand what students know and how they approach individual cognitive tasks such as reading or performing problem solving activities. Two types of assessment have been used: external and embedded. External assessment refers to assessment that is time-limited, often standardized and is used to sort or rank students or schools. Embedded assessment is assessment use daily by a teacher to determine what students know and can do, to understand student progress, and to design daily lessons. Within both types of assessment there is a requirement for balance. As a classroom teacher, the goal should be to create assessments that are balanced—that will help understand what skills students have, the degree of conceptual understanding they possess, and their ability to solve problems. A related goal is to ensure that external assessments chosen by the school, district, or state are balanced and that the mechanism for reporting results to parents and community reflects this balance.

An assessment system can be characterized in terms of its validity and reliability. The assessment system is valid to the extent that it actually assesses the underlying skill or construct it is designed to assess. A properly calibrated postage scale, for example, is a valid means of assessing how much an envelope weighs. But assessing the component skills underlying a complex phenomenon like reading is much more difficult. The difference is that weight is a directly observable feature of physical reality, whereas reading skills are latent (not directly observable) traits within a person's mind. The validity of the assessment system designed to assess such latent traits includes (1) Construct Validity: The theoretical connection between the instrument and the skill to be assessed—provided by the experts in the field who create the instrument, and (2) Criterion Validity: The empirical connection between performance on the instrument and other outcomes recognized as correlates of the skill to be assessed such as correlation with other assessment instruments or relevant outcomes.

As to reliability, the assessment system is reliable to the extent that its results are consistent over repeated administrations. Reliability is a necessary condition for an instrument to be valid. A perfectly valid and reliable instrument will give the same score over and over when assessing the same person in the same skill state. In reality, however, repeated assessments of a single individual do not result in the same score, as the person's score can be expected to increase with practice over time. The reliability of an instrument is therefore established by other means, such as comparing one part of the instrument to another part (split-half reliability) or by the internal consistency of test items, computed as Cronbach's “alpha” reliability coefficient.

### SUMMARY

Systems and methods are disclosed to provide educational assessment of reading performance for a student by receiving a log-in from the student over a network; presenting a new concept to the student through a multimedia presentation; testing the student on the concept at a predetermined learning level; collecting test results for one or more concepts into a test result group; performing a diagnostic assessment of the test result group; and adaptively modifying the predetermined learning level based on the adaptive diagnostic assessment and repeating the process at the modified predetermined learning level for a plurality of sub-tests.

Advantages of the system may include one or more of the following. The system automates the time-consuming diagnostic assessment process and provides an unbiased, consistent measurement of progress. The system provides teachers with specialist expertise and expands their knowledge and facilitates improved classroom instruction. Benchmark data can be generated for existing instructional programs. Diagnostic data is advantageously provided to target students' strengths and weaknesses in the fundamental sub-skills of reading and math, among others. The data paints an individual profile of each student which facilitates a unique learning path for each student. The data also tracks ongoing reading progress objectively over a predetermined period. The system collects diagnostic data for easy reference and provides ongoing aggregate reporting by school or district. Detailed student reports are generated for teachers to share with parents. Teachers can see how students are doing in assessment or instruction. Day-time teachers can view student progress, even if participation is after-school, through an ESL class or Title I program, or from home. Moreover, teachers can control or modify educational track placement at any point in real-time.

Other advantages may include one or more of the following. The reading assessment the system allows the teacher to expand his or her reach to struggling readers and acts as a reading specialist when too few or none are available. The math assessment system allows the teacher to quickly diagnose the student's number computational and measurement skills and shows a detailed list of skills mastered by each math construct. Diagnostic data is provided to share with parents for home tutoring or with tutors or teachers for individualized instructions. All assessment reports are available at any time. Historical data is stored to track progress, and reports can be shared with tutors, teachers, or specialists. For parents, the reports can be used to tutor or teach your child yourself. The web-based system can be accessed at home or when away from home, with no complex software to install.

Other advantages and features will become apparent from the following description, including the drawings and claims.

### BRIEF DESCRIPTION OF THE DRAWINGS

Referring now to the drawings in greater detail, there is illustrated therein structure diagrams for an educational adaptive assessment system and logic flow diagrams for the processes a computer system will utilize to complete the various diagnostic assessments. It will be understood that the program is run on a computer that is capable of communication with consumers via a network, as will be more readily understood from a study of the diagrams.

FIG. 1 shows an exemplary process through which an educational adaptive diagnostic assessment is generated to assess student performance.

FIG. 2 shows details of an exemplary adaptive diagnostic engine.

FIGS. 3A-3G show exemplary reading sub-test user interfaces (UIs), while FIG. 3I shows an exemplary summary report of the tests.

FIG. 4 shows an exemplary summary table showing student performance.

FIG. 5 shows an exemplary client-server system that provides educational adaptive diagnostic assessment.

### DESCRIPTION

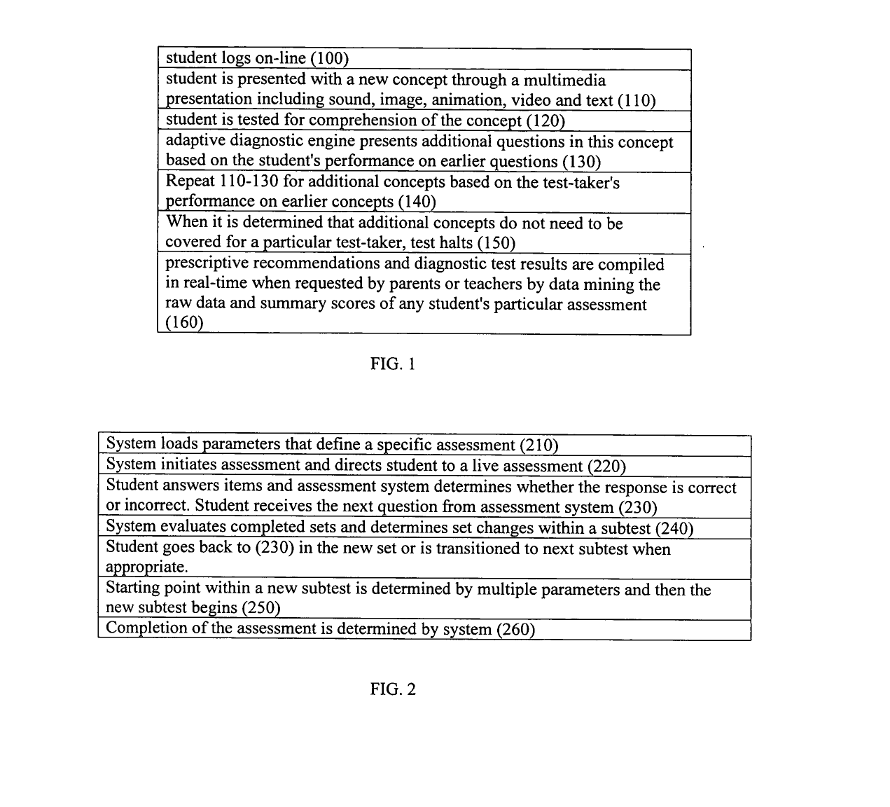

FIG. 1 shows an exemplary process through which an adaptive diagnostic assessment is generated to assess student performance. In FIG. 1, a student logs on-line (100). The student is presented with a new concept through a multimedia presentation including sound, image, animation, video and text (110). The student is tested for comprehension of the concept (120). An adaptive diagnostic engine presents additional questions in this concept based on the student's performance on earlier questions (130). The process is repeated for additional concepts based on the test-taker's performance on earlier concepts (140). When it is determined that additional concepts do not need to be covered for a particular test-taker, the test halts (150). Prescriptive recommendations and diagnostic test results are compiled in real-time when requested by parents or teachers by data mining the raw data and summary scores of any student's particular assessment (160).

In another implementation, a learning level initially is set to a default value or to a previously stored value. For example, the learning level can correspond to a difficulty level for the student. Based, on the currently set learning level, the student is presented with a new concept through a multimedia presentation including sound, image, animation, video and text. After the multimedia presentation, the student is tested for comprehension of the concept and the process is repeated for a predetermined number of concepts. For example, student performance is collected for every five concepts and then the results of the tests are provided to an adaptive diagnostic assessment engine. A learning level is adjusted based on the adaptive diagnostic assessment and the student is tested at the new level. Thus, the process encourages the student to learn and to be tested at new learning levels. When the battery of tests is eventually completed, the adaptive diagnostic assessment engine prints results and recommendations for users such as educators and parents.

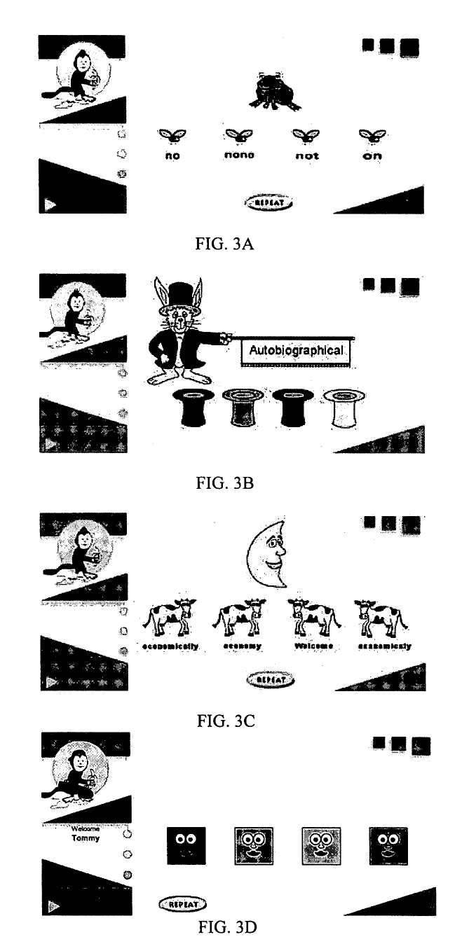

FIG. 2 shows an exemplary adaptive diagnostic assessment engine. In FIG. 2, the system loads parameters that define a specific assessment (210). The student can start the assessment or continue a previously unfinished assessment. Student's unique values determine his/her exact starting point, and based on the student's values, the system initiates assessment and directs student to a live assessment (220). The student answers items and assessment system determines whether the response is correct or incorrect and then present the next question from assessment system to the system (230). The system evaluates the completed sets and determines changes such as changes to the difficulty level by selecting a new set of questions within a subtest (240). The student goes back to (230) to continue the assessment process with a new set or is transitioned to next subtest when appropriate. A starting point within a new subtest is determined by multiple parameters and then the new subtest begins (250). The system continues testing the student until a completion of the assessment is determined by system (260).

One embodiment of FIG. 2 is called Online Adaptive Assessment System for Individual Students (OAASIS). The OAASIS assessment engine resides on a single or multiple application server accessible via the web or network. OAASIS controls the logic of how students are assessed and is independent of the subject being tested. Assessments are defined to OAASIS via a series of parameters that control how adaptive decisions are made while student are taking an assessment in real-time. Furthermore, OAASIS references multiple database tables that hold the actual test times. OAASIS will pull from various tables as it reacts to answers from the test-taker. During use OAASIS can work across multiple computer processors on multiple servers. Students can perform an assessment and in real-time OAASIS will distribute its load to any available CPU.

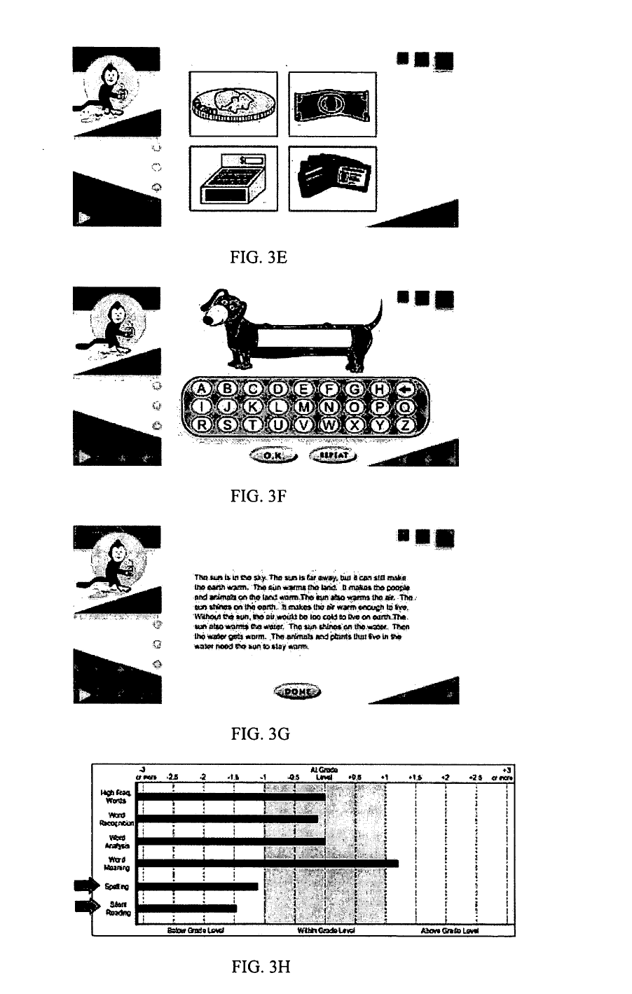

In one embodiment, the engine of FIG. 2 is configured to perform Diagnostic Online Reading Assessment (DORA) where the system assesses students' skills in reading by looking at seven specific reading measures. Initial commencement of DORA is determined by the age, grade, or previously completed assessment of the student. Once the student begins, DORA looks at his or her responses to determine the next question to be presented, the next set, or the next subtest. The three subtests deal with the decoding abilities of a student, high-frequency words, word recognition, and phonics (or word analysis) examine at how students decode words. The performance of the student on each subtest as they are presented affects how he or she will transition to the next subtest. For example a student who performs below grade level on the first high-frequency word subtest will start at a set below his or her grade level in word recognition. The overall performance on the first three subtests as well as the student's grade level will determine whether the fourth subtest, phonemic awareness is presented or skipped. For example students who perform at third or above grade level in high-frequency word, word recognition, and phonics will skip the phonemic awareness subtest. But if the student is at the kindergarten through second grade level he or she will perform the phonemic awareness subtest regardless of his or her performance on the first three subtests. Phonemic awareness is an audio only subtest. See FIG. 3D. This means the student doesn't have to have any reading ability to respond to its questions. The next subtest is word meaning also called oral vocabulary. It measures a student's oral vocabulary. Its starting point is determined by the student's age and scores on earlier subtests. Spelling is the sixth subtest. Its starting point is also determined by earlier subtests. The final subtest is reading comprehension also called silent reading. The starting point is determined by the performance of the student on word recognition and word meaning. On any subtest, student performance is measured as they progress through items. If test items are determined to be too difficult or too easy jumps to easier or more difficult items may be triggered. Also in some cases the last two subtests of spelling and silent reading may be skipped if the student is not able to read independently. This is determined by subtests one to three.

One embodiment of the assessment system examines seven sub-skills of reading that together will paint an accurate picture of the learners' abilities. In addition, an assessment report provides tangible instructional suggestions to begin the student's customized reading instruction. In the embodiment called Diagnostic Online Reading Assessment (DORA), the system assesses students in reading by looking at seven specific reading measures. Initial commencement of DORA is determined by the age, grade, or previously completed assessment of the student. Once the student begins, DORA looks at his or her responses to determine the next question to be presented, the next set, or the next subtest. The three subtests deal with the decoding abilities of a student, high-frequency words, word recognition, and phonics (or word analysis) examine at how students decode words. The performance of the student on each subtest as they are presented affects how he or she will transition to the next subtest. The overall performance on these subtests as well as the student's grade level will determine whether the fourth subtest, phonemic awareness is presented or skipped. Phonemic awareness is an audio subtest. This means the student doesn't have to have any reading ability to respond to its questions. The next subtest is word meaning also called oral vocabulary. It measures a student's oral vocabulary. Its starting point is determined by the student's age and scores on earlier subtests. Spelling is the sixth subtest. Its starting point is also determined by earlier subtests. The final subtest is reading comprehension also called silent reading. The starting point is determined by the performance of the student on word recognition and word meaning. On any subtest, student performance is measured as they progress through items. If test items are determined to be too difficult or too easy jumps to easier or more difficult items may be triggered. Also in some cases the last two subtests of spelling and silent reading may be skipped if the student is not able to read independently. This is determined by subtests one to three.

FIGS. 3A-3F show an exemplary reading test and assessment system that includes a plurality of sub-tests. Turning now to FIG. 3A, an exemplary user interface for a High Frequency Words Sub-test is shown. This subtest examines the learner's recognition of a basic sight-word vocabulary. Sight words are everyday words that people see when reading, often called words of “most-frequent-occurrence.” Many of these words are phonetically irregular (words that cannot be sounded out) and must be memorized. High-frequency words like the, who, what and those make up an enormous percentage of the material for beginning readers. In this subtest, a learner will hear a word and then see four words of similar spelling. The learner will click on the correct word. This test extends through third-grade difficulty, allowing a measurement of fundamental high-frequency word recognition skills.

FIG. 3B shows an exemplary user interface for a Word Recognition Subtest. This subtest measures the learner's ability to recognize a variety of phonetically regular (able to be sounded out) and phonetically irregular (not able to be sounded out) words. This test consists of words from first-grade to twelfth-grade difficulty. These are words that readers become familiar with as they progress through school. This test is made up of words that may not occur as often as high-frequency words but which do appear on a regular basis. Words like tree and dog appear on lower-level lists while ones like different and special appear on higher-level lists. In this subtest, a learner will see a word and hear four others of similar sound. The learner will click on a graphic representing the correct reading of the word in the text.

FIG. 3C shows an exemplary user interface for a Word Analysis Subtest. This subtest is made up of questions evaluating the learner's ability to recognize parts of words and sound words out. The skills tested range from the most rudimentary (consonant sounds) to the most complex (pattern recognition of multi-syllabic words). This test examines reading strategies that align with first-through fourth-grade ability levels. Unlike the previous two tests, this test focuses on the details of sounding out a word. Nonsense words are often used to reduce the possibility that the learner may already have committed certain words to memory. This test will create a measurement of the learner's ability to sound out phonetically regular words. In this subtest, the learner will hear a word and then see four others of similar spelling. The learner will click on the correct word.

FIG. 3D shows an exemplary user interface for a Phonemic Awareness Subtest. This subtest is made up of questions that evaluate the learner's ability to manipulate sounds that are within words. The learner's response is to choose from a choice of 4 different audio choices. Thus this Subtest doesn't require reading skills of the learner. The learner hears a word and is given instructions via audio. Then the learner hears 4 audio choices played aloud that correspond to 4 icons. The learner clicks on the icon that represents the correct audio answer.

FIG. 3E shows an exemplary user interface for a Word Meaning Subtest. This subtest is designed to measure the learner's receptive oral vocabulary skills. Unlike expressive oral vocabulary (the ability to use words when speaking or writing), receptive oral vocabulary is the ability to understand words that are presented orally. In this test of receptive oral vocabulary, learners will be presented with four pictures, will hear a word spoken, and will then click on the picture that matches the word they heard. For example, the learners may see a picture of an elephant, a deer, a unicorn and a ram. At the same time as they hear the word tusk, they should click on the picture of the elephant. All the animals have some kind of horn, but the picture of the elephant best matches the target word. This test extends to a twelfth-grade level. It evaluates a skill that is indispensable to the learner's ability to comprehend and read contextually, as successful contextual reading requires an adequate vocabulary.

FIG. 3F shows an exemplary user interface for a Spelling Subtest. This subtest will assess the learner's spelling skills. Unlike some traditional spelling assessments, this subtest will not be multiple-choice. It will consist of words graded from levels one through twelve. Learners will type the letters on the web page and their mistakes will be tracked. This will give a measure of correct spellings as well as of phonetic and non-phonetic errors.

FIG. 3G shows an exemplary user interface for a Silent Reading Subtest. This subtest, made up of eight graded passages with comprehension questions, will evaluate the learner's ability to respond to questions about a silently read story. Included are a variety of both factual and conceptual comprehension questions. For example, one question may ask, “Where did the boy sail the boat?” while the next one asks, “Why do you think the boy wanted to paint the boat red?” This test measures the learner's reading rate in addition to his or her understanding of the story.

Once the learner has completed the six sections of the assessment, a report as exemplified in FIG. 3H becomes available for online viewing or printing by the master account holder or by any properly authorized subordinate account holder. The report provides either a quick summary view or a lengthy view with rich supporting information. In this example, a particular student's performance is displayed in each sub-skill. The graph shown in FIG. 3H relates each sub-skill to grade level. Sub-skills one year or more behind grade level are marked by a “priority arrow.” At a glance, in Spelling and Silent Reading, the student is one or more years behind grade level. These skills constitute the priority areas on which to focus teaching remediation, as indicated by the arrows. In practice, no student is exactly the same as another. A reader's skill can vary across the entire spectrum of possibilities. This reflects the diverse nature of the reading process and demonstrates that mastering reading can be a complicated experience for any student. Thus, the Reading Assessment embodiment of FIG. 3H diagnostically examines six fundamental reading subskills to provide a map for targeted reading instruction.

After completing an assessment, students can be automatically placed into four instructional courses that target the five skill areas identified by the National Reading Panel. Teachers can modify students' placement into the instructional courses in real-time. Teachers can simply and easily repeat, change, or turn off lessons. The five skills are phonemic awareness, phonics, fluency, vocabulary, and comprehension. In phonemic awareness: the system examines a student's phonemic awareness by assessing his or her ability to distinguish and identify sounds in spoken words. Students hear a series of real and nonsense words and are asked to select the correct printed word from among several distracters. Lessons that target this skill are available for student instruction based upon performance. In phonics, the system assesses a student's knowledge of letter patterns and the sounds they represent through a series of criterion-referenced word sets. Phonetic patterns assessed move from short vowel, long vowel, and consonant blends on to diphthongs, vowel diagraphs, and decodable, multi-syllabic words. Lessons that target this skill are available for student instruction based upon performance. In fluency, the system assesses a student's abilities in this key reading foundation area. The capacity to read text fluently is largely a function of the reader's ability to automatically identify familiar words and successfully decode less familiar words. Lessons that target this skill are available for student instruction based upon performance. In vocabulary, the system assesses a student's oral vocabulary, a foundation skill critical to reading comprehension. Lessons that target this skill are available for student instruction based upon performance.

In other embodiments, the system assesses a student's ability to make meaning of short passages of text. Additional diagnostic data is gathered by examining the nature of errors students make when answering questions (e.g. the ratio of factual to inferential questions correctly answered). Lessons that target this skill are available for student instruction based upon performance.

High-quality PDF reports can be e-mailed or printed and delivered to parents. FIG. 3I shows an exemplary summary report of the tests. These reports inform the parents of their children's individual performance as well as guide instruction in the home setting. The report generated by the system assists schools in intervening before a child's lack of literacy skills causes irreparable damage to the child's ability to succeed in school and in life. Classroom teachers are supported by providing them with individualized information on each of their students and ways they can meet the needs of these individual students. Teachers can sort and manipulate the assessment information on their students in multiple ways. For example, they can view the whole classroom's assessment information on a single page or view detailed diagnostic information for each student.

The reading assessment program shows seven core reading sub-skills in a table that will facilitate the instructor's student grouping decisions. The online instruction option allows teachers to supplement their existing reading curriculum with individualized online reading instruction when they want to work with the classroom as a group but also want to provide one-on-one support to certain individual students. Once a student completes the assessment, the system determines the course his or her supplemental reading instruction might most productively take.

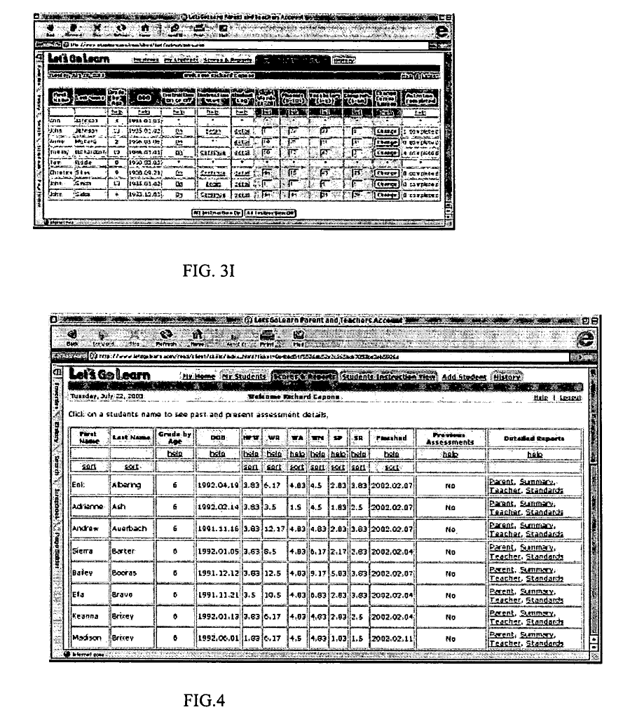

FIG. 4 shows a table view seen by teachers or specialists who log in. Their list of students can be sorted by individual reading sub-skills. This allows for easy sorting for effective small-group instruction and saves valuable class time. Students begin with instruction that is appropriate to their particular reading profiles as suggested by the online assessment. Depending on their profiles, students may be given all lessons across the four direct instructional courses or they may be placed into the one to three courses in which they need supplemental reading instruction.

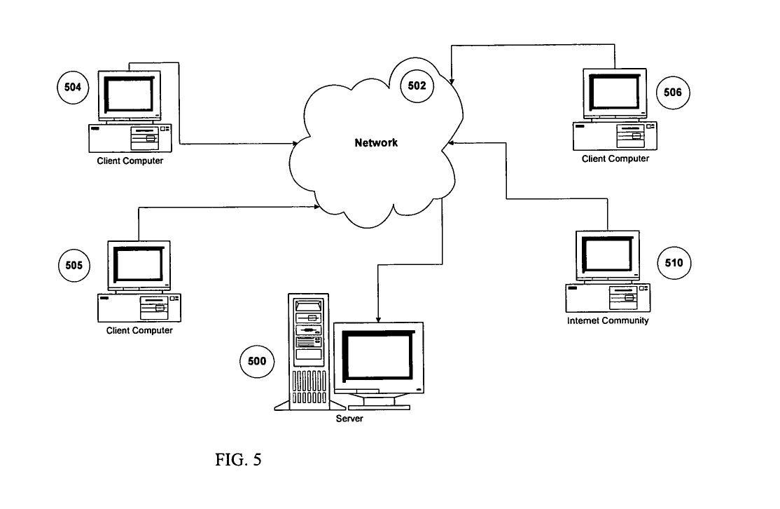

FIG. 5 shows an exemplary on-line system for adaptive diagnostic assessment. A server 500 is connected to a network 502 such as the Internet. One or more client workstations 504-506 are also connected to the network 502. The client workstations 504-506 can be personal computers or workstations running browsers such as Mozilla or Internet Explorer. With the browser, a client or user can access the server 500's Web site by clicking in the browser's Address box, and typing the address (for example, www.vilas.com), then press Enter. When the page has finished loading, the status bar at the bottom of the window is updated. The browser also provides various buttons that allow the client or user to traverse the Internet or to perform other browsing functions.

An Internet community 510 with one or more educational companies, service providers, manufacturers, or marketers is connected to the network 502 and can communicate directly with users of the client workstations 504-506 or indirectly through the server 500. The Internet community 510 provides the client workstations 504-506 with access to a network of educational specialists.

Although the server 500 can be an individual server, the server 500 can also be a cluster of redundant servers. Such a cluster can provide automatic data failover, protecting against both hardware and software faults. In this environment, a plurality of servers provides resources independent of each other until one of the servers fails. Each server can continuously monitor other servers. When one of the servers is unable to respond, the failover process begins. The surviving server acquires the shared drives and volumes of the failed server and mounts the volumes contained on the shared drives. Applications that use the shared drives can also be started on the surviving server after the failover. As soon as the failed server is booted up and the communication between servers indicates that the server is ready to own its shared drives, the servers automatically start the recovery process. Additionally, a server farm can be used. Network requests and server load conditions can be tracked in real time by the server farm controller, and the request can be distributed across the farm of servers to optimize responsiveness and system capacity. When necessary, the farm can automatically and transparently place additional server capacity in service as traffic load increases.

The server 500 supports an educational portal that provides a single point of integration, access, and navigation through the multiple enterprise systems and information sources facing knowledge users operating the client workstations 504-506. The portal can additionally support services that are transaction driven. Once such service is advertising: each time the user accesses the portal, the client workstation 504 or 506 downloads information from the server 500. The information can contain commercial messages/links or can contain downloadable software. Based on data collected on users, advertisers may selectively broadcast messages to users. Messages can be sent through banner advertisements, which are images displayed in a window of the portal. A user can click on the image and be routed to an advertiser's Web-site. Advertisers pay for the number of advertisements displayed, the number of times users click on advertisements, or based on other criteria. Alternatively, the portal supports sponsorship programs, which involve providing an advertiser the right to be displayed on the face of the port or on a drop down menu for a specified period of time, usually one year or less. The portal also supports performance-based arrangements whose payments are dependent on the success of an advertising campaign, which may be measured by the number of times users visit a Web-site, purchase products or register for services. The portal can refer users to advertisers' Web-sites when they log on to the portal. Additionally, the portal offers contents and forums providing focused articles, valuable insights, questions and answers, and value-added information about related educational issues.

The server enables the student to be educated with both school and home supervision. The process begins with the reader's current skills, strategies, and knowledge and then builds from these to develop more sophisticated skills, strategies, and knowledge across the five critical areas such as areas identified by the No Child Left Behind legislation. The system helps parents by bridging the gap between the classroom and the home. The system produces a version of the reading assessment report that the teacher can share with parents. This report explains to parents in a straightforward manner the nature of their children's reading abilities. It also provides instructional suggestions that parents can use at home.

The invention has been described herein in considerable detail in order to comply with the patent Statutes and to provide those skilled in the art with the information needed to apply the novel principles and to construct and use such specialized components as are required. However, it is to be understood that the invention can be carried out by specifically different equipment and devices, and that various modifications, both as to the equipment details and operating procedures, can be accomplished without departing from the scope of the invention itself.

What is claimed is:

1. A method to provide educational assessment of reading performance for a student, comprising:
a. receiving a log-in from the student over a network;
b. presenting a new concept to the student through a multimedia presentation;
c. testing the student on the concept at a predetermined learning level;
d. collecting test results for one or more concepts into a test result group;
e. performing a diagnostic assessment of the test result group; and
f. adaptively modifying the predetermined learning level based on the adaptive diagnostic assessment and repeating (b)-(e) at the modified predetermined learning level for a plurality of sub-tests.

2. The method of claim 1, comprising sub-testing the student with high-frequency words, word recognition, word analysis, phonemic awareness, word meaning, spelling and silent reading.

3. The method of claim 2, wherein the high frequency words sub-testing comprises determining recognition of a basic sight-word vocabulary.
a. Student response time measured and factored into the determination of correct or incorrect for each student's response.

4. The method of claim 2, wherein the word recognition sub-testing comprises determining recognition of phonetically regular and phonetically irregular words.

5. The method of claim 2, wherein the word analysis sub-testing comprises determining recognition of specific phonemic principles
a. Uses real and non-real words to isolate student knowledge of phonetic principles.

6. The method of claim 2, wherein the phonemic awareness sub-testing comprises determining recognition and successful manipulation of sounds within words played aloud to students.

7. The method of claim 2, wherein the word meaning sub-testing comprises determining a receptive oral vocabulary.

8. The method of claim 2, wherein the spelling sub-testing comprises determining correct word spelling.

9. The method of claim 2, wherein the silent reading sub-testing comprises determining comprehension of one or more leveled passages.

10. The method of claim 1, comprising generating a reading profile for the student based on the pattern of subtest results.

11. The method of claim 9, comprising providing a unique reading instructional path to the student based on the reading profile.

12. The method of claim 10, wherein the instructions comprises sight words, phonics, vocabulary, and comprehension instructions.

13. The method of claim 10, wherein the instructions comprise one of: a tutorial format, a reinforcement format, a graded-activity format.

14. The method of claim 10, comprising allowing a teacher or a parent to monitor, control, or adjust an instruction track.

15. The method of claim 1, further comprising generating an output summarizing the test results.

16. The method of claim 1, wherein the multimedia presentation comprises one of: sound, image, animation, video, text.

17. The method of claim 1, wherein the collecting test results comprises capturing results for a predetermined number of concepts.

18. A server to provide educational assessment of reading performance for a student, comprising:
a network interface coupled to a wide area network; and
a processor coupled to the network interface and executing computer readable code to receive a log-in from the student over a network; present a new concept to the student through a multimedia presentation; test the student on the concept at a predetermined learning level; collect test results for one or more concepts into a test result group; perform a diagnostic assessment of the test result group; and adaptively modify the predetermined learning level based on the adaptive diagnostic assessment and repeating (b)-(e) at the modified predetermined learning level for a plurality of sub-tests.

19. The server of claim 18, comprising code to sub-test the student with high-frequency words, word recognition, word analysis, word meaning, spelling and silent reading.

20. A client computer adapted to receive educational assessment of reading performance from a remote server, comprising:
a network interface coupled to the remote server over a wide area network; and
a processor coupled to the network interface and executing computer readable code to receive a log-in from a student over a network; present a new concept to the student through a multimedia presentation; test the student on the concept at a predetermined learning level; collect test results for one or more concepts into a test result group; perform a diagnostic assessment of the test result group; and adaptively modify the predetermined learning level based on the adaptive diagnostic assessment and repeating (b)-(e) at the modified predetermined learning level for a plurality of sub-tests.
